(19) United States
(12) Patent Application Publication
(10) Pub. No.: US 2009/0234836 A1
(43) Pub. Date: Sep. 17, 2009

(54) MULTI-TERM SEARCH RESULT WITH UNSUPERVISED QUERY SEGMENTATION METHOD AND APPARATUS

(75) Inventors: Fuchun Peng, Sunnyvale, CA (US); Yumao Lu, San Jose, CA (US); Nawaaz Ahmed, San Francisco, CA (US); Bin Tan, Champaign, IL (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/048,715

(22) Filed: Mar. 14, 2008

(51) Int. Cl. G06F 7/06

(52) U.S. Cl. 707/5; 707/E17.014

(57) ABSTRACT

Generally, a method and apparatus provides for search results in response to a web search request having at least two search terms in the search request. The method and apparatus includes generating a plurality of term groupings of the search terms and determining a relevance factor for each of the term groupings. The method and apparatus further determines a set of the term groupings based on the relevance factors and therein conducts a web resource search using the set of term groupings, to thereby generate search results. The method and apparatus provides the search results to the requesting entity.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to Internet-based searching and more specifically to improving search result accuracy in response to search requests having more than two search terms.

Existing web-based search systems have difficulty handling search requests with numerous search terms. As used herein, numerous search terms relates to two or more search terms. This is commonly found when searching is done based on a phrase, such as entering a long search string, a popular title, or a song lyric, for example.

Using specific language to better exemplify the existing solutions, suppose a search request is entered having the following search terms: “simmons college sports psychology.” The search engine breaks this search request down in an attempt to decipher or otherwise estimate which terms are of highest importance for searching. For example, the search engine may have to decide between “simmons college” “sports psychology” and “college sports.”

A first approach is a Mutual information based approach. This approach determines correlations between adjacent terms. This is also commonly known as the Units Web Service.

In natural language processing, there has been a significant amount of research on text segmentation, such as noun phrase chunking, where the task is to recognize the chunks that consist of noun phrases, and Chinese word segmentation, where the task is to delimit words by putting boundaries between Chinese characters. Query segmentation is similar to these problems in the sense that they all try to identify meaningful semantic units from the input. However, one may not be able to apply these techniques directly to query segmentation, because Web search query language is very different (queries tend to be short, composed of keywords), and some essential techniques to noun phrase chunking, such as part-of-speech tagging, can not achieve high performance when applied to queries. Thus, detecting noun phrase for information retrieval has been mainly studied in document indexing and has not been addressed in search queries.

A second approach is a supervised learned approach. This approach applies a binary decision at each possible segmentation point, where the segmentation points are the segmentation between various terms. This approach has a limited range context and is specifically designed for noun phrases. Furthermore, due to the supervised learning aspect, this approach requires significant overhead for users to conduct the supervisory learning.

In terms of unsupervised methods for text segmentation, the expectation maximization (EM) algorithm has been used for Chinese word segmentation and phoneme discovery, where a standard EM algorithm is applied to the whole corpus or collection of web resources. Although, running the EM algorithm over the whole corpus is very expensive.

As such, there exists a need for a search query technique that processes and improves the search results for Internet-based searching operations using multi-term search requests.

### SUMMARY OF THE INVENTION

Generally, a method and apparatus provides for search results in response to a web search request having at least two search terms in the search request. The method and apparatus includes generating a plurality of term groupings of the search terms and determining a relevance factor for each of the term groupings. The method and apparatus further determines a set of the term groupings based on the relevance factors and therein conducts a web resource search using the set of term groupings, to thereby generate search results. The method and apparatus provides the search results to the requesting entity.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a processing system that includes an apparatus for providing search results in response to a search request having at least two search terms in the search request;

FIG. 2 illustrates a flowchart of the steps of one embodiment of a method for providing search results in response to a search request having at least two search terms in the search request;

FIG. 3 illustrates a graphical representation of one embodiment of an exemplary unigram model usable for determining relevance factors;

FIG. 4 illustrates a graphical representation of the generation of search term and relevance computation;

FIG. 5 illustrates a graphical representation of another embodiment of the generation of search terms and relevance computation; and

FIG. 6 illustrates a graphical representation of another embodiment of the generation of search terms and relevance computation.

### DETAILED DESCRIPTION OF THE INVENTION

In the following description of the embodiments of the invention, reference is made to the accompanying drawings that form a part hereof, and in which is shown by way of illustration exemplary embodiments in which the invention may be practiced. It is to be understood that other embodiments may be utilized and structural changes may be made without departing from the scope of the present invention.

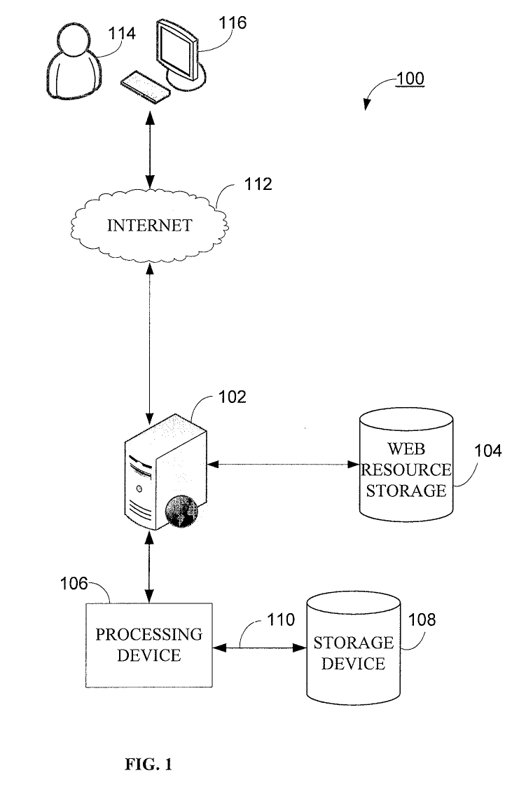

FIG. 1 illustrates a system 100 that includes a search engine search 102 in communication with a plurality of web resource databases 104, a multi-term search processing device 106 and a storage device 108 having executable instructions 110 stored therein. Further in the system is a network connection 112, a user 114 and a user's computer 116.

The server 102 may be any suitable type of search engine server, including any number of possible servers accessible via the network 112 using any suitable connectivity. The storage device 104 may be any suitable type of storage devices in any number of locations accessible by the server 102. The storage device 104 includes web resource information as used by existing web searching engines and web searching techniques.

The processing device 106 may be one or more processing devices operative to perform processing operations in response to executable instructions 110 received from the storage device 108. The storage device 108 may be any suitable storage device operative to store the executable instructions thereon.

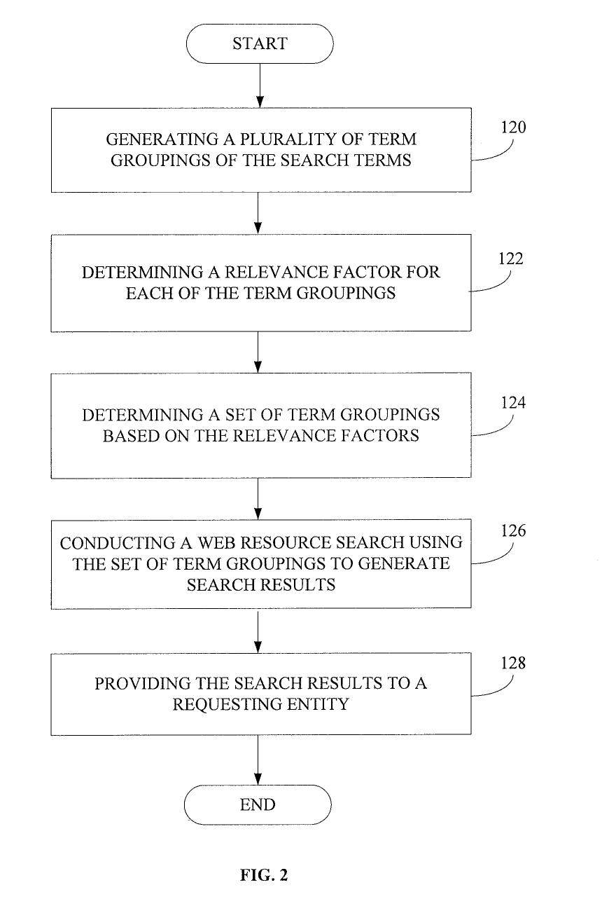

It is further noted that various additional components, as recognized by one skilled in the art, have been omitted from the block diagram of the system 100 for brevity purposes only. Similarly, for brevity's sake, the operation of processing system 100, specifically the processing device 106, are described in conjunction with the flowchart of FIG. 2.

FIG. 2 illustrates steps of a method for providing search results. In a typical embodiment, the user 114 enters a web based search request on the computer 116. The computer 116 may provide an interactive display of a web page from the web server 102, via the Internet 112. It is also noted that the network 112 is generally referred to as the Internet, but may be any suitable network, (e.g. public and/or private), as recognized by of ordinary skill in the art.

Prior to the method of FIG. 2, a user may submit the search request with search terms on the web search portal. The submitted search request includes numerous search terms, including at least two search terms. As an example, the search request may be a string of four words, e.g. “simmons college sports psychology.” Thereby, in this embodiment of the method, the first step, step 120, is generating a plurality of term groupings of the search terms in the search request. This grouping includes denoting the possible variations of the terms. In the example above, the groupings may include “simmons college,” “simmons sports,” “simmons psychology,” “college sports,” “college psychology,” and “sports psychology.” This step may be performed by the processing device 106 in response to the executable instructions 110 from the storage device 108 of FIG. 1.

In this embodiment, a next step, step 122, is determining a relevance factor for each of the term groupings. As described in further detail below, this relevance factor may be determined using unigram model. This determination step may be performed by the processing device 106 in response to the executable instructions 110 from the storage device 108 of FIG. 1.

Once relevance factors are determined, a next step, step 124, is determining a set of the term groupings based on the relevance factors. The term groupings include the terms that are determined to be most relevant based on the relevance factors. In one embodiment, as described below, relevancy includes term groupings with the highest relevance score. By way of example, and for illustration purposes only, this may include determining the set to be the groupings “simmons college” and “sports psychology” from the above example search request. This determination step may be performed by the processing device 106 in response to the executable instructions 110 from the storage device 108 of FIG. 1.

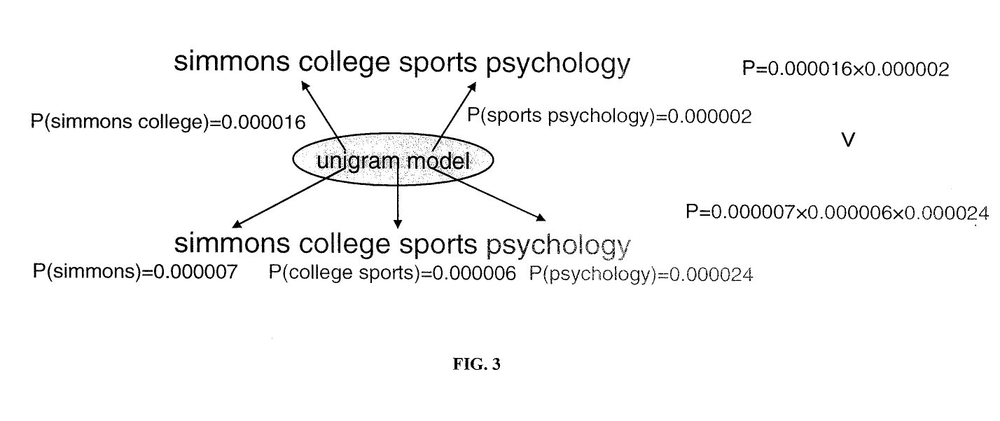

FIG. 3 illustrates a graphical representation of an exemplary unigram model for the sample search term “simmons college sports psychology.” The illustrated unigram model includes probability calculations for the independent sampling from a probability distribution of concepts. For example, the probability distribution is calculated for P(simmons college) and P(sports psychology). This probability distribution is then compared to the probability distribution of P(simmons), P(college sports) and P(psychology).

A next step, step 126, is conducting a web resource search using the set of term groupings to generate search results. The web search may be done by the server 102 in accordance with known searching techniques using the set of term groupings. In another embodiment, as described in further detail below, the searching may be done based a web corpus. The web corpus provides a reduced number of resources that are to be searched, hence improving search speed and reducing processing overhead associated with multi-term searches associated with full search data loads.

In this embodiment, once the search results have been collected, a final step is then providing the search results to a requesting entity, step 128. In the embodiment of FIG. 1, this may include generating a search results page on the web server 102 and providing the search results page to the computer 116 via the Internet 112, whereby the user 112 can then view the search results. In accordance known search result techniques, the results may be active hyperlinks to the specific resources themselves or cached versions of the resource such that upon the user's selection, the computer 116 may then access the corresponding web resource via the Internet 112.

As described in further detail below, the search may further include unsupervised learning regarding term groupings. This unsupervised learning may include accessing automated name grouping resources, where these resources provide direction regarding name groupings. In reference to these resources, a higher degree of accuracy may be achieved regarding sequencing of search terms and this access being unsupervised, reduces computation overhead associated with manual activity regarding prior name grouping techniques.

By way of example, an automated name grouping resource may include a name entity recognizer, an online user generated content data resource, a noun phrase model or any other suitable resource. The name entity recognizer produces entities such as business and locations and the system may match proposed segmentation against name entity recognition results. The online content data may be a recognized source, such as for example the encyclopedia at Wikipedia.com, which is a human edited repository that provides recognizable term groupings also by comparison. The noun phrase model computes the probability that a segment is a noun phrase.

It is when the query is uttered (e.g., typed into a search box) that the concepts are “serialized” into a sequence of words, with their boundaries dissolved. The task of query segmentation, as described herein, is to recover the boundaries that separate the concepts.

Given that the basic units in query generation are concepts, an assumption can be made that they are independent and identically-distributed (I.I.D.). In other words, there is a probability distribution PC of concepts, which is sampled repeatedly, to produce mutually-independent concepts that construct a query. This may be determined to be a unigram language model, with a gram being not a word, but a concept/segment.

The above I.I.D. assumption carries several limitations. First, concepts are not really independent of each other. For example, it is more likely to be observe “travel guide” after “new york” than “new york times”. Second, the probability of a concept may vary by its position in the text. For example, we expect to see “travel guide” more often at the end of a query than at the beginning. While this problem can be addressed by using a higher-order model (e.g., the bigram model) and adding a position variable, this will dramatically increase the number of parameters that are needed to describe the model. Thus for simplicity the unigram model is used, and it proves to work reasonably well for the query segmentation task.

LetT=w₁w₂ . . . wₙ be apiece of text of n words, and S^{T}=s₁s₂ . . . sₘ be a possible segmentation consisting of m segments, where sᵢ=wₖᵢwₖᵢ₊₁ . . . wₖᵢ₊₁−1, 1=k₁<k₂<· . . . ·<kₘ₊₁=n+1.

For a given query Q, if it is produced by the above generative language model, with concepts repeatedly sampled from distribution P_{C} until the desired query is obtained, then the probability of it being generated according to an underlying sequence of concepts (i.e., a segmentation of the query) SQ is:

P(S^{Q})=P(s₁)P(s₂|s₁) . . . P(sₘ|s₁S₂ . . . Sₘ₋₁) Equation 1

The unigram model provides:

P(sᵢ|s₁s₂ . . . sᵢ₋₁)=P_{C}(sᵢ) Equation 2

Based on Equation 1 in combination with Equation 2, this produces:

$$P ( {S}^{Q} ) = {\prod }_{{s}_{i} ∈ {S}^{Q}}^{ } {P}_{C} ( {s}_{i} ) \qquad Equation 3$$

From this, the cumulative probability of generating Q is:

$$P ( Q ) = {\sum }_{{S}^{Q}} P ( {S}^{Q} ) \qquad Equation 4$$

In Equation 4, this is where S^{Q} is one of 2ⁿ⁻¹ different segmentations, with n being the number of query words.

For two segmentations S₁^{T} and S₂^{T} of the same piece of text T, suppose they differ at only one segment boundary, i.e., S₁^{T}=s₁s₂ . . . sₖ₋₁sₖ₊₁Sₖ₊₂ . . . sₘ and S S₂^{T}=s₁s₂ . . . sₖ₋₁s′sₖ₋₁s′sₖ₊₁sₖ₊₂ . . . sₘ where s′ₖ=(sₖsₖ₊₁) is the concatenation of sₖ and sₖ₊₁.

One embodiment favors segmentations with higher probability of generating the query. In the above case, P(S₁^{T})>P(S₂^{T}) if and only if P_{c}(sₖ)P_{c}(sₖ₊₁)>P_{c}(s′ₖ), i.e., when sₖ and sₖ₊₁ are negatively correlated. In other words, a segment boundary is justified if and only if the pointwise mutual information between the two segments resulting from the split is negative:

$$MI ( {s}_{k} , {s}_{k + 1} ) = log \frac{{P}_{c} ( {s}_{k}^{′} )}{{P}_{c} ( {s}_{k} ) {P}_{c} ( {s}_{k + 1} )} < 0 \qquad Equation 5$$

Note that this is differs from the known MI-based approach as it is computed above it is between adjacent segments, rather than words. More importantly, the segmentation decision is non-local (i.e., involving a context beyond the words near the segment boundary of concern): whether sₖ and sₖ₊₁ should be joined or split depends on the positions of sₖ's left boundary and sₖ₊₁'s right boundary, which in turn involve other segment decisions.

In enumerating all possible segmentations, the “best” segmentation will be the one with the highest likelihood to generate the query, in this embodiment. We can also rank them by likelihood and output the top k.

In practice, segmentation enumeration is infeasible except for short queries, as the number of possible segmentations grows exponentially with query length. However, the I.I.D. nature of the unigram model makes it possible to use dynamic programming for computing top k best segmentations. An exemplary algorithm is included in Appendix I. The complexity is O(n k m log(k m)), where n is query length, and m is maximum allowed segment length.

One aspect to be addressed in providing search results in response to multi-term search requests is how to determine the parameters of the unigram language model, i.e., the probability of the concepts, which take the form of variable-length n-grams. One embodiment includes unsupervised learning, therefore it is desirable to estimate parameters automatically from provided textual data.

In one embodiment, a source of data that can be used is a text corpus consisting of a small percentage sample of the web pages crawled by search engine, such as the Yahoo! search engine, for example. We count the frequency of all possible n-grams up to a certain length (n=1, 2, . . . , 5) that occur at least once in the corpus. It is usually impractical to do this for longer n-grams, as their number grows exponentially with n, posing difficulties for storage space and access time. However, for long n-grams (n>5) that are also frequent in the corpus, it is often possible to approximate their counts using those of shorter n-grams.

The processing operation computes lower bounds of long n-gram counts using set in-equalities, and takes them as approximation to the real counts. For example, the frequency for “harry potter and the goblet of fire” can be determined to lie in the reasonably narrow range of [5783, 6399], using 5783 as an estimate for its true frequency.

If we have frequencies of occurrence in a text corpus for all n-grams up to a given length, then we can infer lower bounds of frequencies for longer n-grams, whose real frequencies are unknown. The lower bound is in the sense that any smaller number would cause contradictions with known frequencies.

Let #(x) denote n-gram x's frequency. Let A, B, C be arbitrary n-grams, and AB, BC, ABC be their concatenations. Let #(AB V BC) denote the number of times B follows A or is followed by C in the corpus. This generates:

#(ABC)=#(AB)+#(BC)−#(AB V BC) Equation 6

#(ABC)=>#(AB)+#(BC)−#(B) Equation 7

Equation 6 follows directly from a basic equation on set cardinality, |X∩Y|=|X|+|Y|−|X∪Y| where X is the set of occurrences of B where B follows A and Y is the set of occurrences of B where B is followed by C.

Since #(B)=>#(AB V BC), Equation 7 holds.

Therefore, for any n-gram x=w₁w₂ . . . wₙ (n=>3), if the routine defines:

$${f}_{i , j} ( x ) {-}^{def} \# ( {w}_{1} … {w}_{j} ) + \# ( {w}_{i} … {w}_{n} ) - \# ( {w}_{i} … {w}_{j} ) \qquad Equation 8$$

This generates Equation 9:

$$\# ( x ) \geq {max}_{1 < i < j < n} {f}_{i , j} ( x ) \qquad Equation 9$$

Equation 9 allows for the computation of the frequency lower bound for x using frequencies for sub-n-grams of x, i.e., compute a lower bound for all possible pairs of (i, j), and choose their maximum. In case #(w₁ . . . wⱼ) or #(wᵢ . . . wₙ) is unknown, their lower bounds, which are obtained in a recursive manner, can be used instead. Note that what we obtain are not necessarily greatest lower bounds, if all possible frequency constraints are to be taken into account. Rather, they are best-effort estimates using the above set inequalities.

In reality, not all (i, j) pairs need to be enumerated: if i<=i′<j′<=j, then:

f_{i,j}(x)≧f_{i′,j′}(x) Equation 10

because:

$$( \# ( i , j ) {-}^{def} \# ( {w}_{i} {w}_{i + 1} … {w}_{j} ) ) \qquad Equation 11$$

Equation 11 is in part because of the inequalities used in Equation 7

Equation 10 indicates that there is no need to consider f_{i′,j′}(x) in the computation of Equation 9 if there is a sub-n-gram wᵢ . . . wⱼ longer than w_{i′} . . . w_{j′} with known frequency. This can save a lot of computation.

A second algorithm, as described in Appendix 2, gives the frequency lower bounds for all n-grams in a given query, with complexity O(n²m), where m is the maximum length of n-grams whose frequencies that have been counted.

Suppose we have already segmented the entire text corpus into concepts in a preprocessing step. The methodology can then use Equation 12 so that the frequency of an n-gram will be the number of times it appears in the corpus as a whole segment. For example, in a correctly segmented corpus, there will be very few “york times” segments (most “york times” occurrences will be in the “new york times” segments), resulting in a small value of P_{C}(york times), which makes sense. However, having people manually segment the documents is only feasible on small datasets; on a large corpus it will be too costly.

$${P}_{C} ( x ) = \frac{\# ( x )}{{\sum }_{{x}^{′} ∈ V} \# ( {x}^{′} )} \qquad Equation 12$$

An alternative is unsupervised learning, which does not need human-labeled segmented data, but uses large amount of unsegmented data instead to learn a segmentation model. Expectation maximization (EM) is an optimization method that is commonly used in unsupervised learning, and it has already been applied to text segmentation. The EM algorithm, the expectation step, the unsegmented data is automatically segmented using the current set of estimated parameter values, and in the maximization step, a new set of parameter values are calculated to maximize the complete likelihood of the data which is augmented with segmentation information. The two steps alternate until a termination condition is reached (e.g. convergence).

The major difficulty is that, when the corpus size is very large (for example, 1% of crawled web), it will still be too expensive to run these algorithms, which usually require many passes over the corpus and very large data storage to remember all extracted patterns.

To avoid running the EM algorithm over the whole corpus, one embodiment includes running EM algorithm only on a partial corpus that is specific to a query. More specifically, when a new query arrives, we extract parts of the corpus that overlap with it (we call this the query-relevant partial corpus), which are then segmented into concepts, so that probabilities for n-grams in the query can be computed. All non-relevant parts unrelated to the query of concern are disregarded, thus the computation cost is dramatically reduced.

We can construct the query-relevant partial corpus in a procedure as follows. First we locate all words in the corpus that appear in the query. We then join these words into longer n-grams if the words are adjacent to each other in the corpus, so that the resulting n-grams become longest matches with the query. For example, for the query “new york times subscription”, if the corpus contains “new york times” somewhere, then the longest match at that position is “new york times”, not “new york” or “york times”. This longest match requirement is effective against incomplete concepts, which is a problem for the raw frequency approach as previously mentioned. Note that there is no segmentation information associated with the longest matches; the algorithm has no obligation to keep the longest matches as complete segments. For example, it can split “new york times” in the above case to “new york” and “times” if corpus statistics make it more reasonable to do so. However, there are still two artificial segment boundaries created at each end of a longest match (which means, e.g., “times” cannot associate with the word “square” following it but not included in the query).

Because all non-query-words are disregarded, there is no need to keep track of the matching positions in the corpus. Therefore, the query-relevant partial corpus can be represented as a list of n-grams from the query, associated with their longest match counts, as denoted by Equation 13.

[symbol]

={(x,c(x))|xεQ} Equation 13

In Equation 13, x is an n-gram in query Q, and c(x) is its longest match count.

The partial corpus represents frequency information that is most directly related to the current query. We can think of it as a distilled version of the original corpus, in the form of a concatenation of all n-grams from the query, each repeated for the number of times equal to their longest match counts, with other words in the corpus all substituted by a wildcard, deonted by Equation 14:

$$\underbrace{{x}_{1} {x}_{1 } … {x}_{1}}_{c ( {x}_{1} )} \underbrace{{x}_{2} {x}_{2} … {x}_{2}}_{c ( {x}_{2} )} … \underbrace{{x}_{k} {x}_{k} … {x}_{k}}_{c ( {x}_{k} )} \underbrace{ww … w}_{N - {\sum }_{i} c ( {x}_{i} ) \vert {x}_{i} \vert} \qquad Equation 14$$

In Equation 14, x₁, x₂, . . . , xₖ are all n-grams in the query, w is a wildcard word representing words not present in the query, and N is the corpus length. We denote n-gram x's size by |x|, so N−Σᵢ c(xᵢ)|xᵢ| is the length of the non-overlapping part of the corpus.

Practically, the longest match counts can be computed from raw frequencies efficiently, which are either counted or approximated using lower bounds.

Given query Q, let x be an n-gram in Q, L(x) be the set of words that precede x in Q, and R(x) be the set of words that follow x in Q. For example, if Q is “new york times new subscription”, and x is “new”, then L(x)={times} and R(x)={york, subscription}.

The longest match count for x is essentially the number of occurrences of x in the corpus not preceded by any word from L(x) and not followed by any word from R(x), which we denote as a.

Let b be the total number of occurrences of x, i.e., #(x).

Let c be the number of occurrences of x preceded by any word from L(x).

Let d be the number of occurrences of x followed by any word from R(x).

Let e be the number of occurrences of x preceded by any word from L(x) and at the same time followed by any word from R(x). Then it is easy to see a=b−c−d+e

Algorithm 3, noted in Appendix 3, computes the longest match count. Its complexity is O(l²), where l is the query length.

If we treat the query-relevant partial corpus D as a source of textual evidence, we can use maximum a posteriori estimation (MAP), choosing parameters θ (the set of concept probabilities) to maximize the posterior likelihood given the observed evidence, as illustrated in Equation 15.

θ=argmaxP(D|θ)P(θ) Equation 15

In Equation 15, P(θ) is the prior likelihood of θ. Equation 15 can also be rewritten as Equation 16.

θ=argmin (−log P(D|θ)−log P(θ)) Equation 16

In Equation 16, log P(D|θ) is the description length of the corpus, and −log P(θ) is the description length of the parameters. The first part prefers parameters that are more likely to generate the evidence, while the second part disfavors parameters that are complex to be described. The goal is to reach a balance between the two by minimizing the combined description length.

For the corpus description length, Equation 17 provides the following calculations according to the distilled corpus representation in Equation 14.

$$log P ( D \vert θ ) = {\sum }_{x ∈ Q}^{ } log P ( x \vert θ ) \cdot c ( x ) + log ( 1 - {\sum }_{x ∈ Q}^{ } P ( x \vert θ ) ) \cdot ( N - {\sum }_{x ∈ Q}^{ } c ( x ) \vert x \vert ) \qquad Equation 17$$

In Equation 17, x is an n-gram in query Q, c(x) is its longest match count, |x| is the n-gram length, N is the corpus length, and P(x|θ) is the probability of the parameterized concept distribution generating x as a piece of text. The second part of the equation is necessary, as it keeps the probability sum for n-grams in the query in proportion to the partial corpus size.

The probability of text x being generated can be summed over all of its possible segmentations, as shown by Equation 18.

$$P ( x \vert θ ) = {\sum }_{{S}^{x}} P ( {S}^{x} \vert θ ) \qquad Equation 18$$

In equation 18, Sx is a segmentation of n-gram x. Note that Sx are hidden variables in our optimization problem.

For the description length of prior parameters θ, it is computed as noted in Equation 19.

$$log P ( θ ) = α {\sum }_{x ∈ θ} log P ( x \vert θ ) \qquad Equation 19$$

In Equation 19, α is a predefined weight, xεθ means the concept distribution has a non-zero probability for x, and P(x|θ) is computed as above. This is equivalent to adding a to the longest match counts for all n-grams in the lexicon θ. Thus, the inclusion of long yet infrequent n-grams in the lexicon is penalized for the resulting in-crease in parameter description length.

To estimate the n-gram probabilities with the above minimum description length set-up, one technique is to use variant Baum-Welch algorithms as known in the art. We also follow the variant Baum-Welch algorithms to delete from the lexicon all n-grams that reduce the total description length when deleted. The complexity of the algorithm is O(kl), where k is the number of different n-grams in the partial corpus, and l is the number of deletion phases. In practice, the above EM algorithm converges quickly and can be done without user's awareness.

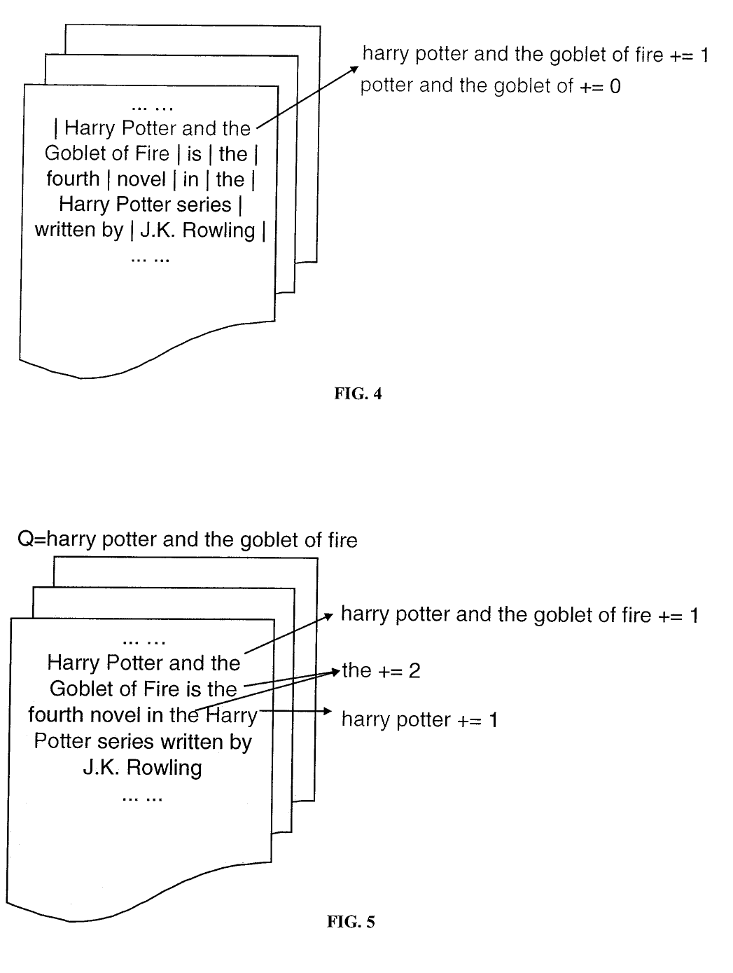

For further description, FIGS. 4-6 illustrate parameter estimation solutions that may be included in the performance of the method and the operations of the apparatus performing the method. FIG. 4 illustrates a possible parameter estimation solution for offline segmentation of the web corpus and to then collect counts for n-grams being segments. For example, this search includes a sample web resource for a search term, such as the book title “Harry Potter and the Goblet of Fire.” In this resource, it is noted that the full “harry potter and the goblet of fire” string is found, based on the +1 designation and the “potter and the goblet of” is specifically designated, outside of the full descriptive string noted above, hence the +0 designation.

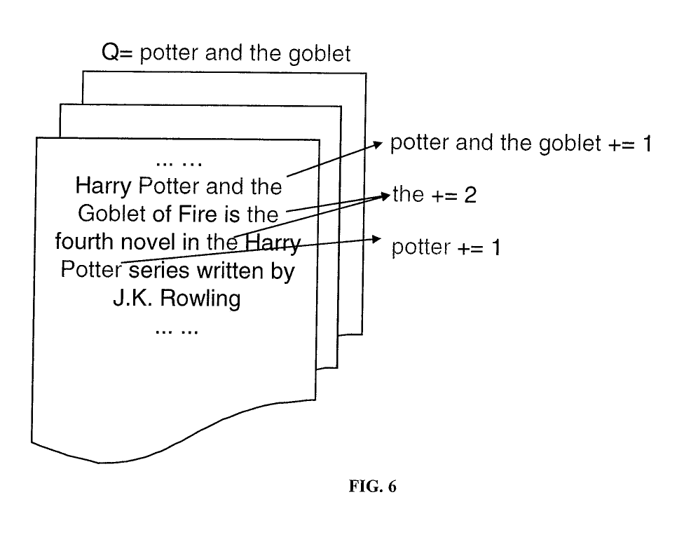

FIGS. 5 and 6 illustrate another parameter estimation solution. This solution includes an online computation where the methodology only considers parts the web corpus overlapping with the query or the longest matches in the query. As described above, this technique includes generation the web corpus first and performing the analysis on this web corpus, thereby reducing the processing overhead and processing time. In FIG. 5, the query is “harry potter and the goblet of fire” and in FIG. 6, the query is “potter and the goblet.” From these query sets, the parameter estimations may be performed consistent with the computations described above.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms memory and/or storage device may be used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

```
APPENDIX I
Input: query w₁w₂ ... wₙ, concept probability distribution P_{c}
Output: top k segmentations with highest likelihood
B[i]: top k segmentations for sub-text w₁w₂ ... wᵢ
For each segmentation b ε B[i], segs denotes the segments and
prob denotes the likelihood of the sub-text given this segmentation
for i in [1..n]
    s ← w₁w₂ ... wᵢ
    if P_{C}(s) > 0
        a ← new segmentation
        a.segs ← {s}
        a.pr ob ← P_{C}(s)
        B[i] ← {a}
    for j in [1..i − 1]
        for b in B[j]
            s ← wⱼwⱼ₊₁ ... wᵢ
            if P_{C}(s) > 0
                a ← new segmentation
                a.segs ← b.segs ∪ {s}
                a.prob ← b.prob × P_{C}(s)
                B[i] ← B[i] ∪ {a}
    sort B[i] by prob
    truncate B[i] to size k
return B[n]
```

```
APPENDIX II
Input: query w₁w₂ ... wₙ, frequencies for all n-grams not
longer than m
Output: frequencies (or their lower bounds) for all n-grams in
the query
C[i, j]: frequency (or its lower bound) for n-gram wᵢ ... wⱼ
for l in [1..n]
    for i in [1..n − l + 1]
        j ← i + l − 1
        if #(wᵢ ... wⱼ) is known
            C[i, j] ← #(wᵢ ... wⱼ)
        else
            C[i, j] ← 0
            for k in [i + 1..j − m]
                C[i, j] ← max (C[i, j], C[i, k + m − 1]
                +C[k, j] − C[k, k + m − 1])
return C
```

```
APPENDIX III
Input: query Q, n-gram x, frquencies for all n-grams in Q
Output: longest match count for x
c(x) ← #(x)
for l ε L(x)
    c(x) ← c(x) − #(lx)
for r ε R(x)
    c(x) ← c(x) − #(xr)
for l ε L(x)
    for r ε R(x)
        c(x) ← c(x) + #(lxr)
return c(x)
```

What is claimed is:

1. A method for providing search results in response to a web search request having at least two search terms in the search request, the method comprising:
generating a plurality of term groupings of the search terms;
determining a relevance factor for each of the term groupings;
determining a set of the term groupings based on the relevance factors;
conducting a web resource search using the set of term groupings to generate search results; and
providing the search results to a requesting entity.

2. The method of claim 1, wherein the generating the plurality of term groupings includes accessing an automated name grouping resource.

3. The method of claim 1, wherein the automated name grouping resource includes at least one of: a name entity recognizer, an online user-generated-content data resource and a noun phrase model.

4. The method of claim 1, wherein the grouping relevance is based on a ranking by probability of the grouping being generated by a unigram model.

5. The method of claim 4, wherein the probability is based on a maximum likelihood estimate.

6. The method of claim 1 further comprising:
generating a web corpus overlapping with search results for the search request; and
conducting the web resource search on the web corpus.

7. The method of claim 6 further comprising:
adjusting the term groupings based on probabilities; and
adjusting the web corpus based on the adjusted term groupings.

8. An apparatus for providing search results in response to a web search request having at least two search terms in the search request, the apparatus comprising:
a computer-readable medium having executable instructions stored thereon; and
a processing device, in response to the executable instructions, operative to:
generate a plurality of term groupings of the search terms;
determine a relevance factor for each of the term groupings;
determine a set of the term groupings based on the relevance factors;
conduct a web resource search using the set of term groupings to generate search results; and
provide the search results to a requesting entity.

9. The apparatus of claim 8, wherein the generating the plurality of term groupings includes accessing an automated name grouping resource.

10. The apparatus of claim 8, wherein the automated name grouping resource includes at least one of: a name entity recognizer, an online user-generated-content data resource and a noun phrase model.

11. The apparatus of claim 8, wherein the grouping relevance is based on a ranking by probability of the grouping being generated by a unigram model.

12. The apparatus of claim 11, wherein the probability is based on a maximum likelihood estimate.

13. The apparatus of claim 8, the processing device, in response to the executable instructions, is further operative to:
generate a web corpus overlapping with search results for the search request; and
conduct the web resource search on the web corpus.

14. The apparatus of claim 13 the processing device, in response to the executable instructions, is further operative to:
adjust the term groupings based on probabilities; and
adjust the web corpus based on the adjusted term groupings.

15. A computer readable medium having executable instructions stored thereon such that, when reads by a processing device, the executable instructions provide a method for providing search results in response to a web search request having at least two search terms in the search request, the method comprising
generating a plurality of term groupings of the search terms;
determining a relevance factor for each of the term groupings;
determining a set of the term groupings based on the relevance factors;
conducting a web resource search using the set of term groupings to generate search results; and
providing the search results to a requesting entity.

16. The computer readable medium of claim 15, wherein the generating the plurality of term groupings includes accessing an automated name grouping resource.

17. The computer readable medium of claim 15, wherein the automated name grouping resource includes at least one of: a name entity recognizer, an online user-generated-content data resource and a noun phrase model.

18. The computer readable medium of claim 15, wherein the grouping relevance is based on a ranking by probability of the grouping being generated by a unigram model.

19. The computer readable medium of claim 18, wherein the probability is based on a maximum likelihood estimate.

20. The computer readable medium of claim 15, where the method further includes:
generating a web corpus overlapping with search results for the search request; and
conducting the web resource search on the web corpus.
